(19) United States
(12) Patent Application Publication
(10) Pub. No.: US 2002/0076501 A1
(43) Pub. Date: Jun. 20, 2002

(54) Crucible coating system

(76) Inventors: Michael Costantini, Hudson, NH (US); Mohan Chandra, Merrimack, NH (US); Keith Matthei, Hollis, NH (US); Alleppey V. Hariharan, Nashua, NH (US)

Correspondence Address: MAINE & ASMUS, 100 MAIN STREET, P O BOX 3445, NASHUA, NH, 03061-3445, US

(21) Appl. No.: 09/998,841

(22) Filed: Nov. 15, 2001

Related U.S. Application Data
(63) Continuation-in-part of application No. 09/827,540, filed on Apr. 6, 2001.
(60) Provisional application No. 60/248,880, filed on Nov. 15, 2000.
(60) Provisional application No. 60/249,023, filed on Nov. 15, 2000.
(60) Provisional application No. 60/290,150, filed on May 10, 2001.

(51) Int. Cl. B05D 7/22; B05D 3/02; B05D 1/02

(52) U.S. Cl. 427/421; 427/233; 427/236; 427/376.2

(57) ABSTRACT

A method for preparing a release coating and applying it to crucibles used to contain molten material while it solidifies, such as in the directional solidification of polycrystalline silicon into ingots, by mixing a release coating power with a dry organic binder into a powder and binder dry mixture, mixing a defoamer with a liquid into a liquid and defoamer mixture, mixing the dry mixture with the liquid and defoamer mixture into a wet release coating, sieving to remove lumps and particles, checking the viscosity, wet-spraying onto a crucible at about room temperature, evaporating the liquid from the wet release coating so as to leave a dry release coating on the crucible, and separating the binder from the dry release coating by thermal decomposition.

This application relates and claims priority for all purposes to pending U.S. applications Ser. No. 60/248880 filed Nov. 15, 2000; 60/249023 filed Nov. 15, 2000; No. 60/290150 filed May 10, 2001; and Ser. No. 09/827540 filed Apr. 6, 2001.

### FIELD OF INVENTION

The invention relates to preparation and application of release coatings for crucibles used in the handling of molten materials that are solidified in the crucible and then removed as ingots, and more particularly to release coatings for crucibles used in the directional solidification of polycrystalline silicon.

### BACKGROUND

Crucibles of fused-silica (quartz) are typically used in directional solidification of polycrystalline silicon. Quartz is chosen primarily for high-purity and availability. There are problems in using quartz, however, as a crucible for the production of silicon by this method.

Silicon in its molten state will react with the quartz crucible that is in contact with it. Molten silicon reacts with quartz to form silicon monoxide and oxygen. Oxygen will contaminate the silicon. Silicon monoxide is volatile, and will react with the graphite components inside the furnace. Silicon monoxide reacts with graphite to form silicon carbide and carbon monoxide. The carbon monoxide will then react with the molten silicon, forming additional volatile silicon monoxide and carbon. Carbon will contaminate the silicon.

The reaction between quartz and silicon promotes adhesion of the silicon to the crucible. This adhesion, combined with a difference in coefficients of thermal expansion between the two materials, creates stress in the silicon ingot, causing it to crack on cooling. It is known in the art that a release coating applied to the inside of the crucible in the area of contact with the ingot can prevent the reaction between silicon and quartz that leads to ingot contamination and cracking. To be effective, the release coating must prevent the silicon from reacting with the quartz crucible, and must not adversely contaminate the silicon either by itself or from contaminants within it.

A variety of materials and techniques are described in the literature, which attempt to solve the problem of reaction and adhesion of the crucible in contact with molten material. For example, U.S. Pat. No. 4256530 by Schmid et al., suggests coating the outside of a quartz crucible with a refractory material, to prevent reaction with adjacent carbon components. The coating does not contact the molten silicon. The method of preparing and applying the coating are, however, undisclosed.

U.S. Pat. No. 5431869 by Kumar, et. al., describes a multi-component release agent of silicon nitride and calcium chloride for silicon processing using a graphite crucible. The silicon nitride coating is applied as a slurry in an organic binder and solvent. The method of preparation and application are largely undisclosed. It is suggested that the binder can be removed after the coating, but the details are undisclosed. The calcium chloride portion is introduced with the bulk silicon, rather than as a coating, to the silicon-nitride coated crucible. The use of silicon nitride alone is described as unfavorable as a crucible coating for directional solidification of silicon.

U.S. Pat. No. 4741925 by Chaudhuri, et. al., describes a silicon nitride coating for crucibles applied by chemical vapor deposition at 1250 degrees Centigrade. U.S. Pat. No. 3746569 discloses the pyrolysis formation of a silicon nitride coating on the walls of a quartz tube. The process requires application temperatures at least 800 degrees C., and tempering at 1250 degrees C. U.S. Pat. No. 4218418 by Schmid, et. al., describes a technique of forming a glass layer inside a silica crucible by rapid heating to prevent cracking of silicon during melt-processing.

U.S. Pat. No. 3660075 by Harbur et al., discloses a coating of niobium carbide or yttrium oxide on a graphite crucible for melting fissile materials. The niobium carbide is applied by chemical vapor deposition, while the yttrium oxide is applied as a colloidal suspension in an aqueous inorganic solution. Details such as the method of preparation and application are largely undisclosed. U.S. Pat. No. 3613633 by Anderson, describes a heated rotating crucible used to hold articles to be coated. The crucible facilitates the containment of an “evaporant” which coats the articles therein. The crucible itself is not, however, used to contain molten material.

Reference is made in “Liquid Encapsulated Bridgman (LEB) Method for Directional Solidification of Silicon Using Calcium Chloride”, by P. S. Ravishankar, Journal of Crystal Growth, 94 (1989) 62-68, to the coating of a silica crucible with silicon nitride. However, no method is detailed for preparing and applying the coating. Furthermore, the resulting ingot quality using this coating is described as poor, due to particle nucleation leading to poor grain-growth and low solar cell efficiency.

Saito, et. al., in “A Reusable Mold in Directional Solidification for Silicon Solar Cells”, Solar Energy Materials, vol 9, (1983) pg 337-345, and in “A New Directional Solidification Technique for Polycrystalline Solar Grade Silicon”, Conf. Record of 15th PV Specialists Conference, 1981, p 576-580, describes a coating of silicon nitride powder which is brushed onto a quartz, silicon carbide coated carbon or silicon nitride sintered mold. The powder is suspended in an organic solvent, which is evaporated by heating. Methods of preparation and application are not detailed, except that the coating needs to be at least 150 microns thick.

Saito reports, “The [silicon nitride] powder was mixed together with a suitable amount of organic solvent, such as liquid polyvinylalcohol, to form a slurry. The slurry was coated by a brush on the inner crucible walls. Then, the crucible was heated in an air ambient at 600° C. for 30 minutes to burn out the organic solvent. The coated layer thus obtained had good mechanical strength against scratching.” However, no method is detailed for preparing and applying the coating. Brushing, we have found, is a difficult way to obtain a uniform coating. In addition, polyvinyl alcohol is not an “organic solvent”, but a solid, water-soluble polymer. The reference to an organic solvent in this context is questionable.

Scaling a laboratory process such as Saito's up to production requirements is also problematic. Saito's crucible was only a few inches across, and contained only 225 g of molten material, while the present technology requires crucibles over two feet across, and contains over 240 kg of molten material. In addition, the size and weight of silicon pieces loaded into the production crucible is much greater, as much as 10 kg in some cases, increasing the possibility of coating damage due to impact by solid silicon, either during loading or while the material is partially molten and the large solid pieces are floating. These differences in size and weight make the physical demands on the coating and the coating process much more profound.

Other publications that mention crucible coatings, usually of silicon nitride, for directional solidification of silicon, but do not discuss methods of preparation or details of application, include: “HEM Technology for Photovoltaic Applications”, Khattak et al, 6th IPSEC Conference, New Delhi, India, 1992, p 117-124; “Growth and Characterization of 200 kg Multicrystalline Silicon Ingots by HEM”, 26th IEEE PVSC Conference, Anaheim, Calif., Sep. 29-30 1997; “Growth of 240 kg Multicrystalline HEM Silicon Ingots”, 2nd WCPEC Conference, Vienna, Austria, Jul. 6-10 1998; “High Efficiency Solar Cells Using HEM Silicon”, First WCPEC Conference, December 5-9, Hawaii, 1994 p 1351-1355; “Characteristics of HEM Silicon in a Reusable Crucible”, 23rd IEEE PV Specialists Conference, Louisville, Ky., May 10-14, 1993, p 73-77; “Analysis and Control of the Performance-Limiting Defects in HEM-Grown Silicon for Solar Cells”, Material Research Society Symposium Proceedings, 1995, v 378 p 767-776; “Lifetime Improvement of Multicrystalline Silicon”, Habler et al., 14th EPVSE Conference, Barcelona, Spain, Jun. 30-Jul. 4, 1997, p 720-723; “3D Distribution Study of Impurities into a Polix Ingot”, Borne et al., 13th European PV Conference, Nice, France, 1995, p 1340-1343; “Study and Conditioning of Defect Areas in Eurosil Multicrystalline Silicon”, Acciarri et al., 13th European PV Conference, Nice, France, 1995, p 1336-1339; and “Selection of a Crucible Material in Contact with Molten Silicon”, Revel et al., 5th EC PV SEC, Athens, Greece, Oct. 17-21 1983, p 1037-1042.

Prior art references include specific references to powdered mold release agents for application to crucibles in the directional solidification of silicon. In addition, the use of chemical vapor deposition, solvent evaporation, high-temperature flame treatment, and other expensive and complex means are mentioned for application of crucible coatings. References are made to specific binders and solvents. Although there is a tremendous emphasis in the literature on controlling the purity of the molten material, such emphasis is lacking in the prior art references as to the powder coating process. Silicon Nitride, for example, is available in a variety of phases, purity, and particle size, which may or may not make them suitable for coating.

References are made to mixing, spraying, or brushing for slurries of powdered coatings. There is no mention, however, of a method to mix, spray, or brush the coating in such a way as to control physical properties such as viscosity, foam content, dispersion quality, in order to provide a uniform coating on the crucible and to avoid contaminating the coating in the process of carrying out these steps.

We have discovered, for example, that the use of a specific silicon nitride powder, Baysinid(R), disclosed by Habler et al., in “Lifetime Improvement of Multicrystalline Silicon”, 14th EPVSE Conference, Barcelona, Spain, Jun. 30-Jul. 4, 1997, p 720-723, in preparing crucible coatings, is heavily aggregated and difficult to disperse, created a poor suspension which was unstable, and caused spraying equipment to clog. This resulted in an extended time required for coating application, and a non-uniform coating which is not reliable in preventing adhesion of molten silicon to the crucible. Ingots were sometimes cracked during operations in which this material was used, due to difficulties related to poor dispersion and clogging. Milling operations using conventional means to properly grind the aggregates to form a stable suspension would contaminate the coating with metal or metal oxide that would contaminate molten silicon.

These examples illustrate how the reviewer of the prior art is led to believe that the selection of specific components and details of their preparation is not a significant problem. We have found, however, that the selection of powders, binders, solvents, and their preparation for applying as a reliable and high-quality coating to a crucible is not in fact known or easily derived, but requires substantial inventiveness to achieve.

### SUMMARY OF THE INVENTION

A priority document and parent application by the same inventors describes a novel and useful release coating system for crucibles, which addresses many of the deficiencies of the prior art technology. In that application a coating system and method is described which permits the loading of silicon without damage and maintains a release layer during melting and solidification of the resulting ingot.

Further novel and useful improvements described herein by the inventors have led to the development of a more durable release coating which can be applied in less time and using less energy than the method described in the parent application. By modifying the temperature of the crucible, and by changing the rate at which the release coating is applied to the crucible, a harder and more durable coating is obtained. A very significant further objective and advantage of invention as presented here is the ability to apply the release coating with conventional spray equipment at normal room temperature and humidity levels.

Additional benefits can be obtained by addition of plasticisers to the formulation to modify its physical properties: increase adhesion to the substrate, modify the drying rate, and increase the flexibility of the dried coating. Benefits are realized in reduced peeling and delaminating and reduce cracking of the dries coating.

Still additional benefits can be obtained by addition or substitution of viscosity-modifying agents, such as water-soluble gums or gelling agents, to or for binder or plasticiser components, which increase the viscosity index of the wet coating. The viscosity index being the ratio of viscosity at a particular shear rate divided by the viscosity at a lower shear rate. Increasing the viscosity index in this way reduces the tendency for the wet coating to run or sag after being applied to a vertical surface. Increasing the viscosity index in this way increases the uniformity of the coating thickness, allows a thicker coating to be applied without runs or sags, and decreases the tendency of the coating to crack due to variations in thickness.

The benefits of this more durable coating are increased resistance to damage during handling and loading, the ability to withstand loading of larger, heavier pieces of silicon without damage, the ability to ship a coated crucible by common carrier without damaging the coating, the ability to remove dust, dirt and other debris by vacuum or soft cloth or brush, or by hand, without damaging the coating, and other benefits of the present invention that will become readily apparent to those skilled in this art.

An additional benefit of the invention of is that the thickness of the wet coating can be measured with a standard wet-film comb commonly used in the paint industry to determine wet-film thickness. Once the wet coating thickness is measured, additional wet coating can be applied to cover thin areas. The use of the wet film comb as part of the method described in the parent application is not possible due to the bumpy surface and relatively low-moisture content of the wet coating due to the high-temperatures and slow coating application rate.

The improved method provides a coating with increased durability compared to previous methods. The increased durability limits the incidence of damage to the coating by impingement of hard crystal loaded into the crucible during the loading step, and during the melt-step due to movement of the solid and semi-solid chunks of crystal.

Reduced damage by impingement reduces the tendency of the crystal to adhere to the crucible during solidification, reducing the incidence of crystal damage due to stress from adhesion to the crucible.

The increased durability limits the incidence of damage to the coating by contact with molten crystal. The increased durability of the coating limits the incidence of damage to the coating during handling, loading, packaging or transport of the crucible, and permits transport of the coated crucibles by truck, ship, rail, air, or other common means without damage to the coating from normal handling methods encountered during such transport.

The hardness of the coating reduces its tendency to produce dust during product recovery, cleanup, or disposal, thereby reducing worker exposure to dust and its associated potential health risks. The coating has better adhesion to the surfaces of the crucible than previous coatings, during and after application and after firing. Better adhesion of the coating reduces the amount of coating that adheres to the product, thereby reducing the need to clean up the product after recovery. Better adhesion of the coating reduces the tendency of the coating to delaminate from the crucible during application and firing, thereby reducing crucible and product rejection rate.

The improved method reduces the time required to apply the coating and the energy required for heating during the application of the coating.

The improved method can be used to apply any liquid-dispersible sinterable powdered coating including, but not limited to, silicon nitride, silicon carbide, zirconium oxide, barium zirconate, and magnesium zirconate.

It is therefore an object of this invention to provide a simple, inexpensive coating system and application process for coating crucibles with a release coating for use in a production environment for the manufacture of ingots of polysilicon or other materials. The system will preferably include a coating material having suitable crucible adhesion and ingot release characteristics when applied to a crucible as a release layer for the molten material, and for which there is a powered form of the material available with a suitable particle size and dispersibility for spray application using commercial equipment and conventional methods.

There will be a safe and inexpensive liquid solvent for the coating material, preferably water, in which to suspend the powder, and an organic binder possessing physical and chemical characteristics that facilitate the application of the coating system to crucibles using commercially available spraying equipment. The coating may include additives to improve its quality, make it more sprayable, easier to apply uniformly, and improve its mixing characteristics and control its physical properties. The powder, binder, and solvent are selected and processed such that the resulting final release coating on the crucible does not adversely contaminate the molten material.

It is a further object of the invention to provide a means to remove the solvent from the coating and harden the binder to prevent movement of the coating during subsequent processing, such as by preheating or holding the crucible at a slightly elevated temperature so as to facilitate the evaporation of the solvent and drying of the coating on the crucible after the spraying operation.

It is another object to provide a means to remove the binder by thermal decomposition from the coating and to densify the final coating so as to minimize damage to the coating during subsequent processing of the molten materials, such as by bisque-firing the crucible by slowly heating the crucible in oxidizing air to well above a temperature at which the binder material will be readily oxidized and dispersed into the air, maintaining the crucible at or near that temperature for a period of time to assure hardening of the remaining layer, and allowing it to cool slowly to room temperature.

Still another object of this invention is to produce a release coating that is durable, such that it will withstand: contact by chunks of silicon during loading and during shifting of the chunks as the silicon melts, handling normally incurred in packaging and shipping by common carrier, brushing, wiping, or hand contact to remove residue such as dirt and other contamination, and other incidental contact as might be experienced in a factory, without disrupting the integrity of the coating or its performance.

Still other objects and advantages of the present invention will become readily apparent to those skilled in this art from the following detailed description, wherein we have shown and described only a preferred embodiment of the invention, simply by way of illustration of the best mode contemplated by us on carrying out our invention.

### BRIEF DESCRIPTION OF THE FIGURES

FIG. 1 is a flowchart of the steps of the preferred embodiment method of the invention as described below.

FIG. 2 is a simplified block diagram of the materials flow of the flowchart of FIG. 1.

### DESCRIPTION OF THE PREFERRED EMBODIMENT

The material to be applied as a crucible release coating is provided in powder form and is readily dispersible in water by high-speed mixing. Readily dispersible refers to a suspension, once prepared at the correct viscosity, which can be applied as a uniform coating by commercially available spray-painting equipment without clogging, and from which particles will not segregate by settling during the time period required for application to the crucible. Such a suspension will exhibit no scratches when tested using a 50 micron Hegman Gauge. High-speed mixing refers to using a shaft mixer with a non-metal or non-metal coated dispersion blade of the “cowles” design or equivalent, such as is available under the Norstone(tm) mark. (No claim is made to the trademark.) The peripheral speed of the mixing blade is maintained at or above 3000 revolutions per minute, such that the vortex formed by the liquid exposes not less than two thirds (⅔) of the diameter of the mixing blade.

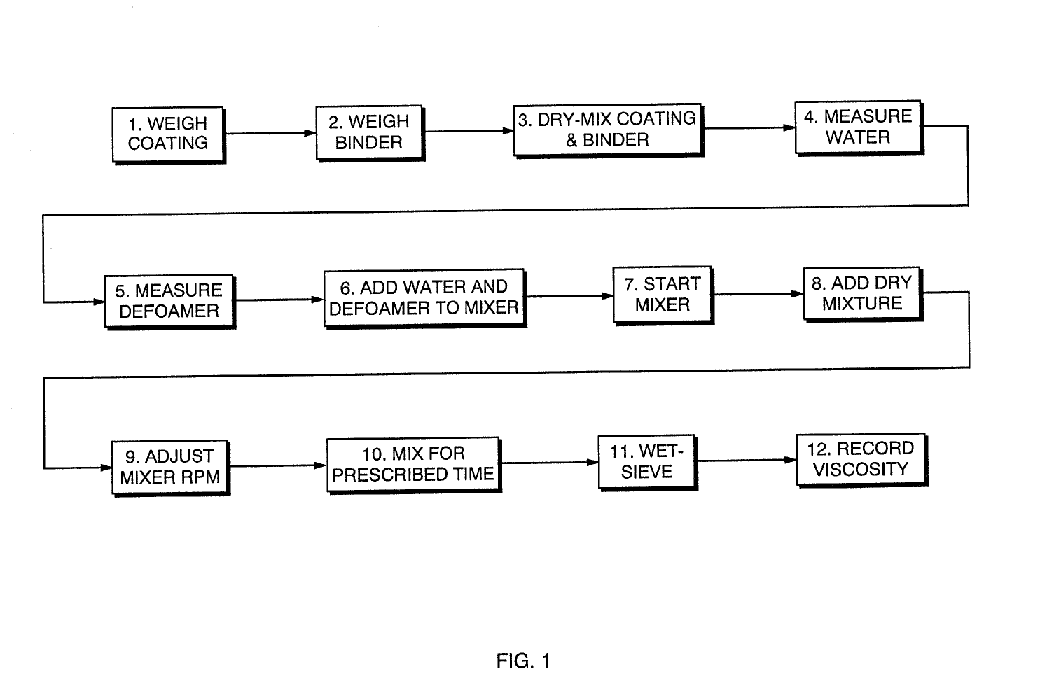

Referring to FIG. 1, a logic flowchart depicting the steps of the process to prepare the coating, the coating powder is weighed (1) and combined with an appropriate weight (2) of dry water-soluble polymer binder material such as cellulose ether. The coating powder and binder are mixed together (3) into a dry mixture until the binder is indistinguishable from the coating powder by visual inspection.

Deionized water having an electrical resistivity greater than 10,000 ohm-cm is measured (4) and poured into a clean plastic or plastic-lined vessel having a volume sufficient to contain the wet coating during preparation. Added to the water is a defoamer (5), such as Polyglycol P1200 polypropylene glycol or equivalent, in the amount of 500-1000 ppm for the volume of water used. Absence of defoamer in the process results in large amounts of foam produced, which will reduce dispersion efficiency, markedly increase the volume and viscosity of the suspension, and reduce the smoothness of the sprayed coating on the crucible.

The water and defoamer mixture are added to the mixer (6) and agitated (7) as described above. While mixing, the dry mixture is added slowly (8) to the water, forming a wet coating. The mixer speed is adjusted (9) during dry mixture addition to maintain the vortex of the liquid. Mixing is continued (10) after dry mixture addition is completed, for a prescribed period of time necessary for the wet coating viscosity to equilibrate. After mixing is completed, the wet coating is sieved (11) through a fine-mesh paint bag, into a clean, dry beaker and its viscosity is recorded (12). After mixing, the wet coating is transferred to a commercially available spray gun such as Binks 95G.

The crucible is mounted in a fixture that holds the crucible in a vertical position with the open end facing the operator. The fixture is capable of rotating the crucible in a vertical plane. A motor that is pre-set by the operator controls the rotation of the crucible in the vertical plane to the desired speed. The frequency of rotation is sufficient to allow for uniform coverage of wet coating delivered from a spray gun moving slowly only in a horizontal plane. The combined rotation of the crucible in the vertical plane and the motion of the spray gun in the horizontal plane are sufficient to achieve a uniform layer of wet coating on the surface of the crucible.

The crucible is maintained at or near normal room conditions of 68 F. and 50% relative humidity. The wet coating is sprayed evenly onto the surface of the crucible at a rate sufficient to prevent running or sagging while wet. The wet coating thickness is at least 3 mils, preferably at least 6 mils, and more preferably at least 10 mils. The thickness of the wet coating must not be so great as to cause cracking of the coating during drying.

This relative rotating motion of the crucible and linear motion of the spray nozzle occurring in the recited planes or in any two orthogonal planes is a preferred way of achieving the uniformity desired, but other motion schemes and orientations of nozzles to crucible are all within the scope of the invention and claims, as will be readily apparent to one skilled in the art.

Once the crucible is coated, the wet coating is permitted to dry slowly to form a dry release coating. The room-temperature application allows the coating to dry slowly, thereby forming a dense, compact layer of dry-release coating that is more durable than coatings that had been rapidly dried by heating.

The dry release coating is then transferred to a kiln which will heat the crucible to a temperature necessary to remove the binder by thermal decomposition in oxidizing air, and to partially densify the coating to a “bisque-fired” condition. An oxidizing atmosphere is required, otherwise the organic material will decompose to carbon, which may cause contamination of the molten material during directional solidification. The crucible is then cooled to a temperature where it can be handled by an operator. The finished crucible is then removed.

The strength of the coating is sufficient after firing to maintain coating integrity during loading and manipulation of the crucible into the furnace. The strength of the coating is sufficient to permit light contact to facilitate brushing, wiping, or hand-contact to remove dirt and debris without danger of damaging the coating, and other incidental contact as might be experienced in a factory. In addition, the coating is durable enough to withstand handling normally incurred in packaging and shipping by common carrier, without disrupting the integrity of the coating or its performance.

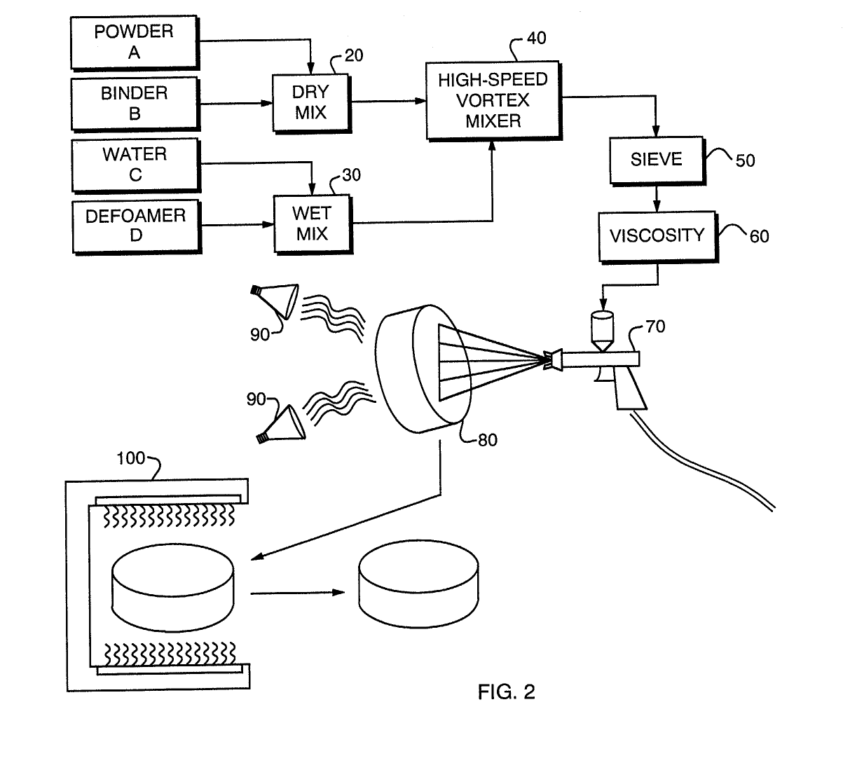

Referring to FIG. 2, a diagrammatic illustration of the materials path of the process correlating to the FIG. 1 steps of the process, coating power A and binder B are weighed and dry mixed together in container 20, dry mixture AB being mixed until binder B is indistinguishable from power A. Separately, in container 30, to the selected volume of deionized water C there is added the 500-1000 parts per million volume of defoamer D, the result being water/defoamer mixture CD. Then water/defoamer mixture CD is added to the high speed mixer 40 first, and the vortex agitation begun. Dry mixture AB is slowly added to mixer 40, with appropriate adjustments to mixer power and speed to maintain the vortex, thus forming the wet release coating ABCD.

Wet release coating ABCD is then passed through sieve 50, a fine mesh paint bag, and into beaker 60, where viscosity is checked. From there, the coating is transferred to spray gun 70, for conventional spray application to at least the interior of crucible 80, at about room temperature and mid range humidity. The wet release coating on the crucible dries slowly, evaporating the water component and leaving a dry release coating consisting substantially of power A and binder B.

Crucible 80 with its dry release coating AB is then transferred to kiln 100, where the crucible is heated to a temperature necessary to remove binder B by thermal decomposition, leaving a final release coating A, and to partially densify the remaining release coating to a “bisque-fired” condition. Crucible 80 is then cooled and removed for use in the production of polysilicon.

As an example of the preferred method, 390 grams of silicon nitride powder (M-11® grade, H. C. Stark, Newton, Mass.), having a volume average particle diameter of 0.7 microns, with 90% by volume of less than 1.2 microns, and 10% by volume less than 0.5 microns, is thoroughly mixed in dry form in a glass container using a Teflon rod, with 72 grams of cellulose ether (Methocel® A15-LV-Dow Chemical, Midland, Minn.) as a binder to form a dry mixture. The silicon nitride powder has a level of iron less than 7 ppm, and of copper 0.5 ppm. The binder has a viscosity in water of 15 centipoises at a concentration of 2 percent by weight. The binder has iron at 20 ppm and copper 0.5 ppm. Into another glass container of 2 liters capacity, 1500 ml of deionized water, having an electrical conductivity of 17,000 megaohms-cm, is mixed with 1 ml of polypropylene glycol (P1200®, Dow Chemical, Midland, Minn.) defoamer. The water and defoamer are mixed using a high-shear mixer. The mixer is fitted with a 3″ diameter polyurethane impeller (Norstone®, Inc.), and is operating at a speed capable of generating a vortex that covers only ⅓ the diameter of the impeller.

The dry mixture is added to the water mixture in 50 ml increments over a period of 10 minutes, to form a wet release coating. During the addition, the speed of the mixer is adjusted to maintain the vortex, with ⅓ diameter or less impeller coverage. Once the dry mixture is added, the wet coating is mixed for 10 minutes to completely dissolve the binder. After mixing, the wet coating is removed from the mixer and poured slowly through a standard fine-mesh paint bag into a 2 liter glass beaker and allowed to de-air for 15 minutes. The paint bag trapped no lumps or grit particles.

The condition of the coating is a smooth suspension with no lumps or grit detectable when rubbed through the fingers. A sample is withdrawn to a standard 50 micron Hegman gauge that confirms dispersion quality by displaying no scratches down to zero reading. The viscosity is tested using a Zahn #4 cup with a result of 20 seconds. The wet coating is sprayed using a spray gun (Binks, Inc. 95-G) onto a silica crucible (Zyarock® Part# EW01515 Vesuvius-McDanel, Inc.) maintained at 68 Degrees F., and dried in air for 3 hours.

During the spray process the coating is sprayed slowly and evenly to avoid runs or drips. The wet coating thickness is measured with a standard wet film comb (Elcometer® 112) and reads between 8 and 14 mils over 21 measurement areas equally spaced throughout the surface of the coating. The dried coating is smooth with no cracks. The total application time is 30 minutes. Drying time is 180 minutes. The coating hardness is measured using a Durometer which reads 90 Shore A. The coated crucible is heated in air to 1095 degrees C. over a period of 9 hours, maintained at 1095 degrees C. for 3 hours, and allowed to cool slowly to room temperature. The coating is then measured with a durometer which shows it has been hardened to 97 Shore A.

As another example of the preferred method including the addition of plasticiser, 390 grams of silicon nitride powder (M-11® grade, H. C. Stark, Newton, Mass.), having a volume average particle size of 0.7 microns, with 90 percent by volume of less than 1.2 microns, and 10 percent by volume of less than 0.5 microns, is thoroughly mixed in dry form with 72 grams of cellulose ether (Methocel® A15-LV-Dow Chemical, Midland, Minn.) binder to form a dry mixture in a glass container using a Teflon rod. The silicon nitride powder has a level of iron less than 7 ppm, and copper 0.5 ppm. The binder has a viscosity in water of 15 centipoises at a concentration of 2 percent by weight. The binder has iron at 20 ppm and copper 0.5 ppm. Into another glass container of 2 liters capacity, 1500 ml of deionized water, having an electrical conductivity of 17,000 megaohms-cm, is mixed with 1 ml of polypropylene glycol (P1200®, Dow Chemical, Midland, Minn.) defoamer, and 15 ml polyethylene glycol (E400®, (Dow Chemical, Midland, Minn.) plasticiser. The water and defoamer are mixed using a high-shear mixer. The mixer is fitted with a 3″ diameter polyurethane impeller (Norstone®, Inc.), and is operating at a speed capable of generating a vortex that covers only ⅓ the diameter of the impeller.

The dry mixture is added to the water mixture in 50 ml increments over a period of 10 minutes, to form a wet release coating. During the addition, the speed of the mixer is adjusted to maintain the vortex, with ⅓ diameter or less impeller coverage. Once the dry mixture is added, the wet coating is mixed for 10 minutes to completely dissolve the binder. After mixing, the wet coating is removed from the mixer and poured slowly through a standard fine-mesh paint bag into a 2 liter glass beaker and allowed to de-air for 15 minutes. The paint bag trapped no lumps or grit particles.

The condition of the coating is a smooth suspension with no lumps or grit detectable when rubbed through the fingers. A sample is withdrawn to a standard 50 micron Hegman gauge that confirms dispersion quality by displaying no scratches down to zero reading. The viscosity is tested using a Zahn #4 cup with a result of 20 seconds. The wet coating is sprayed using a spray gun (Binks, Inc. 95-G) onto a silica crucible (Zyarock® Part# EW01515 Vesuvius-McDanel, Inc.) maintained at 68 F. (Farenheit) degrees, and dried in air for 3 hours.

During the spray process the coating is sprayed slowly and evenly to avoid runs or drips. The wet coating thickness is measured with a standard wet film comb (Elcometer® 112) and reads between 8 and 14 mils over 21 measurement areas equally spaced throughout the surface of the coating. The dried coating is smooth with no cracks. The total application time is 30 minutes. Drying time is 180 minutes. The coated crucible is heated in air to 1095 C. (Centigrade) degrees over a period of 9 hours, maintained at 1095 C. degrees for 3 hours, and allowed to cool slowly to room temperature.

As still yet another example of the invention, there is a preferred method using polyvinyl alcohol as a binder, 328 grams of polyvinyl alcohol 20 percent by weight binder solution in water (OPTAPIX® PAF2-PEMCO, Baltimore, Md.) mixed with 297 grams of deionized water, having an electrical conductivity of 17,000 megaohms-cm. The silicon nitride powder has a level of iron less than 7 ppm, and copper 0.5 ppm. 1 ml of polypropylene glycol (P1200®, Dow Chemical, Midland, Minn.) defoamer is added. 153 grams of silicon nitride powder (M-11® grade, H. C. Stark, Newton, Mass.), is added and mixed using a high-shear mixer. The mixer is fitted with a 3″ diameter polyurethane impeller (Norstone®, Inc.), and is operating at a speed capable of generating a vortex that covers only ⅓ the diameter of the impeller.

The dry powder is added to the liquid solution in 50 ml increments over a period of 10 minutes, to form a wet coating. During the addition, the speed of the mixer is adjusted to maintain the vortex, with ⅓ diameter or less impeller coverage. After mixing, the wet coating is removed from the mixer and poured slowly through a standard fine-mesh paint bag into a 2-liter glass beaker and allowed to de-air for 60 minutes. The paint bag trapped no lumps or grit particles.

The condition of the coating is a smooth suspension with no lumps or grit detectable when rubbed through the fingers. The viscosity is tested using a Zahn #4 cup with a result of less than 120 seconds. The wet coating is sprayed using a spray gun (Binks, Inc. 95-G) onto a silica panel (Zyarock® Part# EW01515 Vesuvius-McDanel, Inc.) maintained at 68 F. degrees, and dried in air for 16 hours.

During the spray process the coating is sprayed slowly and evenly to avoid runs or drips. The wet coating thickness is measured with a standard wet film comb (Elcometer® 112) to a maximum of 40 mils. The dried coating contains air bubbles but has no cracks. The coating is hard to the touch. The coated crucible is heated in air to 1095 C. degrees over a period of 9 hours, maintained at 1095 C. degrees for 3 hours, and allowed to cool slowly to room temperature.

As will be realized, the invention is capable of other and different embodiments, and its several details are capable of modifications in various obvious respects, all without departing from the invention.

For example, there is within the scope of the invention, a method for applying a release coating to crucibles used to form molten material into a solid ingot, by mixing a release coating power with a dry organic binder into a powder and binder dry mixture, mixing a defoamer with a liquid solvent into a solvent mixture, mixing the dry mixture with the solvent mixture into a wet release coating, sieving the wet release coating so as to remove lumps and particles, wet-spraying the release coating onto a crucible at about room temperature, evaporating the solvent mixture from the wet release coating so as to leave a dry release coating on the crucible, and decomposing the binder from the dry release coating.

The crucible may be a fused-silica crucible. The molten material may be silicon.

The wet-spraying may consist of rotating the crucible in a first plane, directing a spray nozzle towards the crucible while moving the spray nozzle in a second plane where the second plane is substantially orthogonal to the first plane, and spraying the release coating through the spray nozzle so as to coat the crucible.

The organic binder may be cellulose ether. The cellulose ether may have a viscosity of between 12 and 120 centipoises, preferably between 12 and 55 centipoises, more preferably between 12 and 18 centipoises at 20 degrees C., at a concentration in water of at two percent by weight. The cellulose ether may be present in a concentration of between 2 and 50 percent by weight of the total weight of the release coating powder plus cellulose ether, preferably between 5 and 20 percent by weight of the total weight of release coating powder plus cellulose ether, and more preferably between 14 and 18 percent by weight of the total weight of release coating powder plus cellulose ether.

The organic binder may be polyvinyl alcohol. The polyvinyl alcohol may have a viscosity of between 5 and 50 centipoises at 20 degrees C., preferably between 5 and 15 centipoises, at a concentration in water of four percent by weight. The polyvinyl alcohol may be present in a concentration of between 2 and 50 percent by weight of the total weight of release coating powder plus polyvinyl alcohol, preferably between 5 and 20 percent by weight of the total weight of release coating powder plus polyvinyl alcohol, more preferably between 14 and 18 percent by weight of the total weight of release coating powder plus polyvinyl alcohol.

The release coating powder may be a compound from among a group of compounds consisting of silicon nitride, silicon carbide, yttrium-oxide-stabilized zirconium oxide, magnesium-oxide-stabilized zirconium oxide, barium zirconate, magnesium zirconate, strontium zirconate, and calcium zirconate.

The liquid solvent may be deionized water with an electrical resistivity of at least 10,000 megaohms-cm. The release coating powder may have a particle size of 90 percent by volume of less than 4 microns diameter.

The defoamer may be one of a group of defoamers consisting of polypropylene glycol and polyethylene glycol. The defoamer may be present at a concentration of between 500 and 2000 parts per million by volume of the liquid solvent, preferably between 500 and 1000 parts per million by volume of the liquid solvent.

The wet release coating may have a viscosity as measured by Zahn#4 cup of between 5 and 120 seconds, preferably between 10 and 80 seconds, more preferably between 15 and 30 seconds.

The step of decomposing may be the slow heating of the crucible in oxidizing air to at least the thermal decomposition temperature of the binder. And the step of wet-spraying may include assuring the viscosity of the wet release coating is suitable for spray application.

Other and various equivalent embodiments within the scope of the claims that follow will be readily apparent to those skilled in the art, from the specification, figures and abstract provided.

We claim:

1. A method for applying a release coating to crucibles used to form molten material into a solid ingot, comprising the steps:
(a) mixing a release coating power with a dry organic binder into a powder and binder dry mixture,
(b) mixing a defoamer with a liquid solvent into a solvent mixture,
(c) mixing said dry mixture with said solvent mixture into a wet release coating,
(d) sieving said wet release coating so as to remove lumps and particles,
(e) wet-spraying said wet release coating onto a said crucible at about room temperature,
(f) evaporating said solvent mixture from said wet release coating so as to leave a dry said release coating on said crucible, and
(g) decomposing said binder from said dry release coating.

2. A method for applying a release coating according to claim 1, said crucible being a fused-silica crucible.

3. A method for applying a release coating according to claim 1, said molten material being silicon.

4. A method for applying a release coating according to claim 1, said step of wet-spraying comprising the steps of:
rotating said crucible in a first plane,
directing a spray nozzle towards said crucible while moving said spray nozzle in a second plane, said second plane being substantially orthogonal to said first plane,
spraying said release coating through said spray nozzle.

5. A method for applying a release coating according to claim 1, said organic binder being cellulose ether.

6. A method for applying a release coating according to claim 5, said cellulose ether having a viscosity of between 12 and 120 centipoises, preferably between 12 and 55 centipoises, more preferably between 12 and 18 centipoises at 20 degrees C., at a concentration in water of at two percent by weight.

7. A method for applying a release coating according to claim 5, said cellulose ether present in a concentration of between 2 and 50 percent by weight of the total weight of said release coating powder plus cellulose ether, preferably between 5 and 20 percent by weight of the total weight of release coating powder plus cellulose ether, and more preferably between 14 and 18 percent by weight of the total weight of release coating powder plus cellulose ether.

8. A method for applying a release coating according to claim 1, said organic binder being polyvinyl alcohol.

9. A method for applying a release coating according to claim 8, said polyvinyl alcohol having a viscosity of between 5 and 50 centipoises at 20 degrees C., preferably between 5 and 15 centipoises, at a concentration in water of four percent by weight.

10. A method for applying a release coating according to claim 8, said polyvinyl alcohol present in a concentration of between 2 and 50 percent by weight of the total weight of release coating powder plus polyvinyl alcohol, preferably between 5 and 20 percent by weight of the total weight of release coating powder plus polyvinyl alcohol, more preferably between 14 and 18 percent by weight of the total weight of release coating powder plus polyvinyl alcohol.

11. A method for applying a release coating according to claim 1, said release coating powder comprising a compound from among the group of compounds consisting of silicon nitride, silicon carbide, yttrium-oxide-stabilized zirconium oxide, magnesium-oxide-stabilized zirconium oxide, barium zirconate, magnesium zirconate, strontium zirconate, calcium zirconate.

12. A method for applying a release coating according to claim 1, said liquid solvent being deionized water with an electrical resistivity of at least 10,000 megaohms-cm.

13. A method for applying a release coating according to claim 1, said release coating powder having a particle size 90% by volume less than 4 microns diameter.

14. A method for applying a release coating according to claim 1, said defoamer comprising one of a group of defoamers consisting of polypropylene glycol and polyethylene glycol.

15. A method for applying a release coating according to claim 14, said defoamer present at a concentration of between 500 and 2000 parts per million by volume of said unit volume of said liquid solvent, preferably between 500 and 1000 parts per million by volume of said unit volume of said liquid solvent.

16. A method for applying a release coating according to claim 1, said wet release coating having a viscosity as measured by Zahn#4 cup of between 5 and 120 seconds, preferably between 10 and 80 seconds, more preferably between 15 and 30 seconds.

17. A method for applying a release coating according to claim 1, said step of decomposing comprising slowly heating said crucible in oxidizing air to at least the thermal decomposition temperature of said binder.

18. A method for applying a release coating according to claim 1, further comprising prior to said step of wet-spraying the step:
assuring viscosity of said wet release coating is suitable for spray application.

19. A method for applying a release coating to a fused-silica crucible for forming molten silicon into a solid ingot, comprising the steps:
(a) mixing a release coating power with cellulose ether into a powder and binder dry mixture, said release coating powder comprising a compound from among the group of compounds consisting of silicon nitride, silicon carbide, yttrium-oxide-stabilized zirconium oxide, magnesium-oxide-stabilized zirconium oxide, barium zirconate, magnesium zirconate, strontium zirconate, and calcium zirconate, said release coating powder having a particle size 90% by volume less than 4 microns diameter, said cellulose ether having a viscosity at 20 C. degrees at a concentration in water of two percent by weight of between 12 and 120 centipoises, preferably between 12 and 55 centipoises, more preferably between 12 and 18 centipoises, said cellulose ether present in a concentration of between 2 and 50 percent by weight of the total weight of release coating powder plus cellulose ether, preferably between 5 and 20 percent by weight of the total weight of release coating powder plus cellulose ether, and more preferably between 14 and 18 percent by weight of the total weight of release coating powder plus cellulose ether,
(b) mixing a defoamer with a liquid solvent into a solvent mixture, said liquid solvent being deionized water with an electrical resistivity of at least 10,000 megaohms-cm, said defoamer comprising one of a group of defoamers consisting of polypropylene glycol and polyethylene glycol, said defoamer present at a concentration of between 500 and 2000 parts per million by volume of said unit volume of liquid solvent, preferably between 500 and 1000 parts per million by volume of said unit volume of liquid solvent,
(c) mixing said dry mixture with said solvent mixture into a wet release coating,
(d) sieving said wet release coating so as to remove lumps and particles,
(e) assuring viscosity of said wet release coating as measured by Zahn#4 cup is between 5 and 120 seconds, preferably between 10 and 80 seconds, more preferably between 15 and 30 seconds,
(f) wet-spraying said wet release coating onto a said crucible at about room temperature,
(g) evaporating said solvent mixture from said wet release coating so as to leave a dry said release coating on said crucible,
(h) slowly heating said crucible in oxidizing air to at least 400 C. degrees, and
(i) cooling said crucible to ambient temperature.

20. A method for applying a release coating to a fused-silica crucible for forming molten silicon into a solid ingot, comprising the steps:
(a) mixing a release coating power with polyvinyl alcohol into a powder and binder dry mixture, said release coating powder comprising a compound from among the group of compounds consisting of silicon nitride, silicon carbide, yttrium-oxide-stabilized zirconium oxide, magnesium-oxide-stabilized zirconium oxide, barium zirconate, magnesium zirconate, strontium zirconate, and calcium zirconate, said release coating powder having a particle size 90% by volume less than 4 microns diameter, said polyvinyl alcohol having a viscosity at 20 C. degrees at a concentration in water of four percent by weight of between 5 and 50 centipoises, preferably between 5 and 15 centipoises, said polyvinyl alcohol present in a concentration of between 2 and 50 percent by weight of the total weight of release coating powder plus polyvinyl alcohol, preferably between 5 and 20 percent by weight of the total weight of release coating powder plus polyvinyl alcohol, more preferably between 14 and 18 percent by weight of the total weight of release coating powder plus polyvinyl alcohol.
(b) mixing a defoamer with a liquid solvent into a solvent mixture, said liquid solvent being deionized water with an electrical resistivity of at least 10,000 megaohms-cm, said defoamer comprising one of a group of defoamers consisting of polypropylene glycol and polyethylene glycol, said defoamer present at a concentration of between 500 and 2000 parts per million by volume of a unit volume of said liquid solvent and preferably between 500 and 1000 parts per million,
(c) mixing said dry mixture with said solvent mixture into a wet release coating,
(d) sieving said wet release coating so as to remove lumps and particles,
(e) assuring viscosity of said wet release coating as measured by Zahn#4 cup is between 5 and 120 seconds, preferably between 10 and 80 seconds, and more preferably between 15 and 30 seconds,
(f) wet-spraying said wet release coating onto a said crucible at between 60 and 80 F. degrees and between 40 and 60 percent relative humidity,
(g) evaporating said solvent mixture from said wet release coating so as to leave a dry said release coating on said crucible,
(h) heating said crucible in oxidizing air to at least 400 C. degrees, and
(i) cooling said crucible to ambient temperature.
